(19) United States
(12) Patent Application Publication
(10) Pub. No.: US 2021/0340401 A1
(43) Pub. Date: Nov. 4, 2021

(54) SLIP-RESISTANT COATING, METHOD OF COATING A SUBSTRATE AND A COATED SUBSTRATE

(71) Applicant: Construction Research & Technology GmbH, Trostberg (DE)

(72) Inventors: Chia WANG, Shakopee, MN (US); Kevin KASUNIC, Austin, TX (US); Brian MULLEN, Delano, MN (US); Brent LAVASSEUR, Maple Grove, MN (US); Lori PROOPS, Rosemount, MN (US)

(21) Appl. No.: 17/272,321

(22) PCT Filed: Sep. 27, 2019
(86) PCT No.: PCT/US2019/053372

§ 371 Date: Feb. 28, 2021

Related U.S. Application Data
(60) Provisional application No. 62/738,532, filed on Sep. 28, 2018.

(51) Int. Cl. C09D 175/04; C09D 5/00; C09D 7/61; C09D 7/40; C09K 3/14

(52) U.S. Cl. CPC C09D 175/04; C09D 5/00; C09D 7/61; C08K 2003/2272; C09K 3/149; C08K 2201/019; C09D 7/70

(57) ABSTRACT

A coating composition for application to a substrate includes a polymer matrix and a mineral aggregate substantially free of crystalline silica. The mineral aggregate is utilized as a partial or complete replacement for aggregate containing free respirable crystalline silica traditionally included in anti-slip or anti-skid coating compositions. Methods of making the coating and coating a substrate with the coating composition to provide a slip- or skid-resistant coating on a surface of a substrate are also disclosed.

### TECHNICAL FIELD

The present disclosure is directed to a coating for a substrate, a method of making a coating for a substrate, a method of coating a substrate with a coating, and a substrate coated with a coating. The present disclosure is more particularly directed to a slip-resistant coating for a substrate, a method of making a slip-resistant coating for a substrate, a method of coating a substrate with a slip-resistant coating, and a substrate coated with a slip-resistant coating.

### BACKGROUND

Crystalline silica is a natural mineral that is found in construction materials such as sand, stone, brick, concrete, and mortar. The primary source of crystalline silica is quartz, a mineral found in nearly all mineral deposits. Significant known health risks are associated with exposure to crystalline silica, including silicosis, lung cancer, chronic obstructive pulmonary disease (“COPD”) and kidney disease.

According to the National Institute for Occupational Safety and Health (NIOSH), millions of U.S. workers are exposed to respirable crystalline silica in a variety of industries and occupations, including construction, sandblasting and mining. Because of the health risks in the construction industry associated with exposure to crystalline silica, the Occupational Safety and Health Administration (“OSHA”) has developed and issued an industry standard to limit worker exposure to respirable crystalline silica dust in construction work. This standard can be found at 29 C.F.R. § 1926.1153 (2016). The OSHA standard requires employers to take significant steps to protect workers from exposure to respirable crystalline silica.

Silica sand, which includes respirable free crystalline silica, is commonly used as an anti-slip or anti-skid additive in floor coating compositions. A floor coating is applied to the surface of a horizontal floor substrate by methods widely known in the industry to provide a seamless layer of a protective coating. Prior to curing the floor coating composition, the silica sand additive is typically spread by broadcasting across the surface of the floor substrate by a contractor. The particles of silica sand become trapped within the floor coating near the surface of the coating to provide an anti-slip or anti-skid texture on the surface of the floor coating.

The act of spreading the silica sand onto the liquid floor coating exposes workers to possible inhalation of respirable crystalline silica from the silica sand. Thus, there is a need in the art to develop anti-slip coating compositions and methods of using anti-slip coating compositions to coat target substrates that minimizes or eliminates workers' exposure to respirable crystalline silica. There is also a need in the art to develop coating materials that exhibit improved impact, abrasion and slip resistance, as compared to coating materials containing aggregate composed primarily of crystalline silica.

### SUMMARY

According to a first aspect, disclosed is a coating comprising a polymer matrix and a mineral aggregate substantially free of crystalline silica.

According to a second aspect, disclosed is a coated substrate comprising a substrate having opposite facing first and second major surfaces, and at least one layer of a coating comprising a polymer matrix and a mineral aggregate substantially free of crystalline silica on at least a portion of one of said first or second major surfaces of said substrate.

According to a third aspect, disclosed is a method for coating a surface of a substrate with a coating composition, said method comprising coating at least one layer of a coating comprising a polymer matrix and a mineral aggregate substantially free of crystalline silica on at least a portion of a surface of said substrate.

According to a fourth aspect, disclosed is a method for coating a substrate with a coating composition, said method comprising coating at least one layer of a polymer coating on at least a portion of a surface of said substrate and spreading a plurality of a mineral aggregate substantially free of crystalline silica onto said polymer coating.

According to a fifth aspect, disclosed is a floor comprising a floor substrate having opposite facing first and second major surfaces and at least one layer of a coating comprising a polymer matrix and a mineral aggregate substantially free of crystalline silica on at least a portion of one of said first or second major surfaces of said floor substrate.

According to a sixth aspect, disclosed is a deck comprising a deck substrate having opposite facing first and second major surfaces and at least one layer of a coating comprising a polymer matrix and a mineral aggregate substantially free of crystalline silica on at least a portion of one of said first or second major surfaces of said deck substrate.

According to a seventh aspect, disclosed is a method for making a coating composition comprising mixing together a polymer matrix and a plurality of a mineral aggregate substantially free of crystalline silica.

### BRIEF DESCRIPTION OF DRAWINGS

FIG. 1 is a cross-sectional view of a substrate coated with an illustrative slip-resistant coating comprising a polymer matrix and an aggregate comprising amorphous silica as a main component.

FIG. 2 is a cross-sectional view of a substrate coated with a base coat, such as a primer, which is then top coated with an illustrative slip-resistant coating comprising a polymer matrix and an aggregate comprising amorphous silica as a main component.

FIG. 3 is a scanning electron microscope (SEM) image of smooth round crystalline silica particles.

FIG. 4 is an SEM image of rough angular amorphous silica particles.

FIGS. 5A and 5B are photographs of illustrative embodiments of the disclosed coating composition applied to a substrate and showing a surface texture suitable as a slip resistant coating for pedestrian and vehicular applications.

### DETAILED DESCRIPTION

The present disclosure is directed to a coating composition for a substrate that minimizes or eliminates the amount of free crystalline silica present in the coating composition. While the coating composition minimizes, substantially eliminates, or completely eliminates the presence of free crystalline silica, the coating composition also possesses improved processability and anti-slip performance over the current art.

The present disclosure provides coating compositions having non-skid properties. As used herein, the terms “non-skid,” “non-slip,” “anti-skid,” “anti-slip,” “slip resistant,” or “skid resistant” coatings are used interchangeably, and refer to a coating that dries to a rough, abrasive surface that resists sliding of pedestrians and/or vehicles on building floors, balcony decks, parking decks, parking ramps, plaza decks, stadium decks, stairs and the like.

The coating composition comprises a polymer matrix and a mineral aggregate substantially free of crystalline silica. Without limitation, and only by way of illustration, the polymer matrix of the coating composition may be selected from at least one of epoxy, polyaspartic, polymethacrylate, polyurethane, polyurea, or polysulfide.

According to an illustrative embodiments, the polymer matrix of the coating composition comprises a polyurethane. A polyurethane is a reaction product of at least isocyanate, at least one polyol, and optional other reactants. Any known isocyanate may be utilized to form the polyurethane polymer. The isocyanate may include at least one of aromatic isocyanates, aliphatic isocyanates, cycloaliphatic isocyanates, aryl aliphatic isocyanates or mixtures thereof. The isocyanate component may be a diisocyanate or a triisocyanate or mixtures thereof. Examples of aromatic isocyanates which may be utilized include but are not limited to methylene diphenyl diisocyanates (MDI), toluene diisocyanates (TDI), polymeric methylene diphenyl diisocyanates (PMDI), p-phenyl diisocyanates (PDI), naphthalene diisocyanates (NDI), aliphatic isocyanates such as hexamethylene diisocyanates (HDI), hexamethylene diisocyanate trimers (HDI Trimers), dicyclohexylmethane diisocyanates (H₁₂MDI), isophorone diisocyanates (IPDI), cyclohexane diisocyanate (CHDI), tetramethylxylylene diisocyanate (TMXDI) or mixtures thereof.

Any known polyol may be utilized to form the polyurethane polymer. Useful polyols include compounds having at least one isocyanate-reactive functionality. Suitable polyols include, without limitation, polyether polyols, polyester polyols, polyalkylene glycols, polybutadiene polyols, alkylene diols and combinations thereof. Suitable polyester polyols include for example those based on caprolactone, which are also referred to as “polycaprolactones”.

Suitable polyurethane polymers are commercially available from BASF Corporation (Florham Park, N.J., USA) under the designations MASTERSEAL 225, 275 and 295. MASTERSEAL 225 is a liquid applied one-component moisture-curing polyurethane coating. MASTERSEAL 275 and 295 are both liquid applied two-component polyurethane coatings. A suitable epoxy coating is commercially available from BASF Corporation (Florham Park, N.J., USA) under the designations MASTERSEAL C350.

Without limitation, and only by way of illustration, suitable mineral aggregate for use in the coating is commercially available from Green Diamond Performance Materials under the designations Crystal Sand 1636, 1650, 2050 and 3060.

The mineral aggregate used in the disclosed coating composition is substantially free of crystalline silica. As used herein, substantially free of crystalline silica means that the total aggregate content of the coating composition includes from 0 to about 20 weight percent crystalline silica. The total aggregate content includes crystalline silica particles and/or aggregate having least one region of crystalline silica. According to certain embodiments, substantially free of crystalline silica means that the total aggregate content of the coating composition includes from 0 to about 15 weight percent crystalline silica. According to certain embodiments, substantially free of crystalline silica means that the total aggregate content of the coating composition includes from 0 to about 10 weight percent crystalline silica. According to certain embodiments, substantially free of crystalline silica means that the total aggregate content of the coating composition includes from 0 to about 9 weight percent crystalline silica. According to certain embodiments, substantially free of crystalline silica means that the total aggregate content of the coating composition includes from 0 to about 8 weight percent crystalline silica. According to certain embodiments, substantially free of crystalline silica means that the total aggregate content of the coating composition includes from 0 to about 7 weight percent crystalline silica. According to certain embodiments, substantially free of crystalline silica means that the total aggregate content of the coating composition includes from 0 to about 6 weight percent crystalline silica. According to certain embodiments, substantially free of crystalline silica means that the total aggregate content of the coating composition includes from 0 to about 5 weight percent crystalline silica. According to certain embodiments, substantially free of crystalline silica means that the total aggregate content of the coating composition includes from 0 to about 4 weight percent crystalline silica. According to certain embodiments, substantially free of crystalline silica means that the total aggregate content of the coating composition includes from 0 to about 3 weight percent crystalline silica. According to certain embodiments, substantially free of crystalline silica means that the total aggregate content of the coating composition includes from 0 to about 2 weight percent crystalline silica. According to certain embodiments, substantially free of crystalline silica means that the total aggregate content of the coating composition includes from 0 to about 1 weight percent crystalline silica. According to certain embodiments, substantially free of crystalline silica means that the total aggregate content of the coating composition includes from 0 to about 0.5 weight percent crystalline silica. According to certain embodiments, substantially free of crystalline silica means that the total aggregate content of the coating composition includes from 0 to about 0.4 weight percent crystalline silica. According to certain embodiments, substantially free of crystalline silica means that the total aggregate content of the coating composition includes from 0 to about 0.3 weight percent crystalline silica. According to certain embodiments, substantially free of crystalline silica means that the total aggregate content of the coating composition includes from 0 to about 0.2 weight percent crystalline silica. According to certain embodiments, substantially free of crystalline silica means that the total aggregate content of the coating composition includes from 0 to about 0.1 weight percent crystalline silica. According to certain embodiments, substantially free of crystalline silica means that the total aggregate content of the coating composition includes from 0 to about 0.01 weight percent crystalline silica. According to certain embodiments, substantially free of crystalline silica means that the total aggregate content of the coating composition includes from 0.5 to about 5 weight percent crystalline silica. According to certain embodiments, substantially free of crystalline silica means that the total aggregate content of the coating composition includes from 0.5 to about 3 weight percent crystalline silica. According to certain embodiments, substantially free of crystalline silica means that the total aggregate content of the coating composition includes from 0.5 to about 2 weight percent crystalline silica. According to certain embodiments, substantially free of crystalline silica means that the total aggregate content of the coating composition includes from 0.5 to about 1 weight percent crystalline silica. According to certain illustrative embodiments, the coating composition is free of crystalline silica.

According to certain embodiments, the coating composition comprises a mineral aggregate comprising amorphous silica as a main component. According to certain embodiments, the coating composition comprises a mineral aggregate comprising greater than about 25 weight percent amorphous silica. According to certain embodiments, the coating composition comprises a mineral aggregate comprising greater than about 35 weight percent amorphous silica. According to certain embodiments, the coating composition comprises a mineral aggregate comprising greater than about 45 weight percent amorphous silica. According to certain embodiments, the coating composition comprises a mineral aggregate comprising greater than about 50 weight percent amorphous silica. According to certain embodiments, the coating composition comprises a mineral aggregate comprising greater than about 55 weight percent amorphous silica. According to certain embodiments, the coating composition comprises a mineral aggregate comprising from about 20 to about 80 weight percent amorphous silica. According to certain embodiments, the coating composition comprises a mineral aggregate comprising from about 30 to about 70 weight percent amorphous silica. According to certain embodiments, the coating composition comprises a mineral aggregate comprising from about 40 to about 60 weight percent amorphous silica. According to certain embodiments, the coating composition comprises a mineral aggregate comprising from about 45 to about 55 weight percent amorphous silica.

According to certain embodiments, the coating composition comprises a mineral aggregate comprising from about 30 to about 70 weight percent amorphous silica and from about 20 to about 40 weight percent magnesia. According to certain embodiments, the coating composition comprises a mineral aggregate comprising from about 40 to about 60 weight percent amorphous silica and from about 25 to about 35 weight percent magnesia. According to certain embodiments, the coating composition comprises a mineral aggregate comprising from about 40 to about 60 weight percent amorphous silica, from about 25 to about 35 weight percent magnesia, and from about 10 to about 20 weight percent iron oxide. According to certain embodiments, the coating composition comprises a mineral aggregate comprising from about 40 to about 60 weight percent amorphous silica, from about 25 to about 35 weight percent magnesia, from about 10 to about 20 weight percent iron oxide, and from about 0.5 to about 5 weight percent alumina.

According to certain embodiments, the mineral aggregate has a size ranging from about 2400 μm to about 100 μm. According to certain embodiments, the mineral aggregate has a size ranging from about 1700 μm to about 150 μm. According to certain embodiments, the mineral aggregate has a size ranging from about 1200 μm to about 180 μm.

The mineral aggregate may comprise amorphous silica particles having a substantially non-round or non-spherical particle shape. According to certain embodiments, the mineral aggregate comprises amorphous silica particles having a non-round or non-spherical particle shape. According to certain embodiments, the mineral aggregate may comprise amorphous silica particles having a rough angular shape. According to certain illustrative embodiments, the ratio of the longest dimension to the shortest dimension of the disclosed mineral aggregate of the coating composition is greater than the ratio of the longest dimension to the shortest dimension of crystalline silica aggregate. According to certain embodiments, the ratio of the longest dimension to the shortest dimension of the disclosed mineral aggregate of the coating composition is greater than 1.25:1. According to certain embodiments, the ratio of the longest dimension to the shortest dimension of the disclosed mineral aggregate of the coating composition is greater than 1.3:1. According to certain embodiments, the ratio of the longest dimension to the shortest dimension of the disclosed mineral aggregate of the coating composition is greater than 1.4:1. According to certain embodiments, the ratio of the longest dimension to the shortest dimension of the disclosed mineral aggregate of the coating composition is greater than 1.5:1. According to certain embodiments, the ratio of the longest dimension to the shortest dimension of the disclosed mineral aggregate of the coating composition is greater than 1.6:1. According to certain embodiments, the ratio of the longest dimension to the shortest dimension of the disclosed mineral aggregate of the coating composition is greater than 1.7:1. According to certain embodiments, the ratio of the longest dimension to the shortest dimension of the disclosed mineral aggregate of the coating composition is greater than 1.8:1. According to certain embodiments, the ratio of the longest dimension to the shortest dimension of the disclosed mineral aggregate of the coating composition is greater than 1.9:1. According to certain embodiments, the ratio of the longest dimension to the shortest dimension of the disclosed mineral aggregate of the coating composition is greater than 2:1.

According to certain embodiments, the aggregate component of the coating composition may also include an aggregate other that the mineral aggregate substantially free of crystalline silica. The aggregate component of the coating composition may include thermoplastic and/or thermoset aggregates in addition to the mineral aggregate substantially free of crystalline silica. Without limitation, and only by way of illustration, the aggregate component of the coating composition may further include at least one of aluminum oxide, glass beads, polypropylenes, polyethylenes, polyesters, acrylic plastics, polycarbonates, aromatic polycarbonates, polyarylates, polyarylethers, polyetherimides, polyimides or polyamides.

The ratio of polymer matrix to aggregate in the coating composition may be in the range of about 1:1 to about 20:1. According to certain illustrative embodiments, the ratio of polymer matrix to aggregate in the coating composition is in the range of 2:1 to 10:1. According to certain illustrative embodiments, the ratio of polymer matrix to aggregate in the coating composition is in the range of 3:1 to 10:1. According to certain illustrative embodiments, the ratio of polymer matrix to aggregate in the coating composition is in the range of 4:1 to 10:1. According to certain illustrative embodiments, the ratio of polymer matrix to aggregate in the coating composition is in the range of 5:1 to 10:1. According to certain illustrative embodiments, the ratio of polymer matrix to aggregate in the coating composition is in the range of 6:1 to 10:1. According to certain illustrative embodiments, the ratio of polymer matrix to aggregate in the coating composition is in the range of 7:1 to 10:1. According to certain illustrative embodiments, the ratio of polymer matrix to aggregate in the coating composition is in the range of 8:1 to 10:1. According to certain illustrative embodiments, the ratio of polymer matrix to aggregate in the coating composition is in the range of 9:1 to 10:1.

According to certain illustrative embodiments, the ratio of polymer matrix to aggregate in the coating composition is about 2:1. According to certain illustrative embodiments, the ratio of polymer matrix to aggregate in the coating composition is about 3:1.5. According to certain illustrative embodiments, the ratio of polymer matrix to aggregate in the coating composition is about 4:1. According to certain illustrative embodiments, the ratio of polymer matrix to aggregate in the coating composition is about 6:1. According to certain illustrative embodiments, the ratio of polymer matrix to aggregate in the coating composition is about 8:1.

To control the settling of the disclosed mineral aggregate and to provide a more homogenous mixture of polymer matrix and aggregate for a longer period of time, the density of the disclosed mineral aggregate should approximate the density of the polymer matrix. According to certain illustrative embodiments, for example, the density of the polymer matrix and disclosed mineral aggregate should be within ±25 percent of each other. According to other illustrative embodiments, the density of the polymer matrix and disclosed mineral aggregate should be within ±20 percent of each other. According to other illustrative embodiments, the density of the polymer matrix and disclosed mineral aggregate should be within ±15 percent of each other. According to other illustrative embodiments, the density of the polymer matrix and disclosed mineral aggregate should be within ±10 percent of each other. According to other illustrative embodiments, the density of the polymer matrix and disclosed mineral aggregate should be within ±5 percent of each other. According to other illustrative embodiments, the density of the polymer matrix and disclosed mineral aggregate should be within ±4 percent of each other. According to other illustrative embodiments, the density of the polymer matrix and disclosed mineral aggregate should be within ±3 percent of each other. According to other illustrative embodiments, the density of the polymer matrix and disclosed mineral aggregate should be within ±2 percent of each other. According to other illustrative embodiments, the density of the polymer matrix and disclosed mineral aggregate should be within ±1 percent of each other.

The disclosed coating composition may also contain auxiliaries or additives such as abrasion resistance improvers, absorbents, rheological modifiers, plasticizers, antifoaming agents, antifouling agents, thixotropic agents, pigments, fillers, additional aggregate, fungicides, mildewcides, biocides, extenders, reinforcing agents, flow control agents, catalysts, wetting agents, adhesion promoters, thickening agents, flame-retarding agents, antioxidants, elastomers, anti-settling agents, diluents, UV light stabilizers, air release agents, solvents, dispersing aids, and mixtures thereof.

Suitable pigments may be selected from organic and inorganic color pigments which may include titanium dioxide, carbon black, lampblack, zinc oxide, natural and synthetic red, yellow, brown and black iron oxides, toluidine and benzidine yellow, phthalocyanine blue and green, and carbazole violet, and extender pigments including ground and crystalline silica, barium sulfate, magnesium silicate, calcium silicate, mica, micaceous iron oxide, calcium carbonate, zinc powder, aluminum and aluminum silicate, aluminum paste, gypsum, feldspar and the like. The amount of pigment that is used to form the coating composition is understood to vary, depending on the particular application, and can be zero when a clear composition is desired.

A primer may be utilized to promote adhesion and bonding of the coating composition to the surface of an underlying substrate. The primer may penetrate the pore structure of the underlying structure to provide a high bond layer for the disclosed coating composition. Individuals of ordinary skill in the art can easily determine suitable primers without undue experimentation. Without limitation, a useful primer for application to the underlying substrate is commercially available from BASF Corporation (Florham Park, N.J., USA) under the designations MASTERSEAL P173, P255 and P176. The primer may be applied to the surface of the substrate to be protected by any conventional method for application of a primer to a surface of a substrate. Without limitation, application of the primer may be performed using a roller, brush, sprayer, squeegee and the like. Individuals of ordinary skill in the art can easily determine suitable methods for application of the primer without undue experimentation.

A basecoat may be applied to the surface of an underlying substrate. Without limitation, useful basecoats for application to the underlying substrate is commercially available from BASF Corporation (Florham Park, N.J., USA) under the designations MASTERSEAL M200, M205, M265 and 350. Without limitation, application of the basecoat may be performed using a roller, brush, sprayer, squeegee and the like. Individuals of ordinary skill in the art can easily determine suitable methods for application of the basecoat without undue experimentation.

A filler, patch or other repair material may also be utilized to fill small cracks, defects, flaws, or voids in the underlying substrate to which the coating composition is to be applied to provide a smooth and even surface for application of the coating composition. Such preparation provides a smooth surface to promote intimate contact and even support of subsequent layers and minimizes surface irregularities which would otherwise become stress concentration sites. Without limitation, an example of a useful filler or repair material that can be utilized is commercially available from BASF Corporation (Florham Park, N.J., USA) under the designations MASTEREMACO 1060 and 1061. Individuals of ordinary skill in the art can easily determine suitable fillers without undue experimentation.

It should be understood that when a range of values is described in the present disclosure, it is intended that any and every value within the range, including the end points, is to be considered as having been disclosed. For example, a ratio in “a range of from about 1:1 to about 20:1” is to be read as indicating each and every possible ratio between 1:1 and 20:1. Similarly, a compositional range of “about 40 to about 60 weight percent amorphous silica” is to be read as indicating each and every possible value within 40 and 60, including the end points. It is to be understood that the inventors appreciate and understand that any and all values within a range of values are to be considered to have been specified, and that the inventors have possession of the entire range and all the values within the range.

In the present disclosure, the term “about” used in connection with a value is inclusive of the stated value and has the meaning dictated by the context. For example, the term “about” includes at least the degree of error associated with the measurement of the particular value. One of ordinary skill in the art would understand the term “about” is used herein to mean that an amount of “about” of a recited value results in the desired degree of effectiveness in the compositions and/or methods of the present disclosure. One of ordinary skill in the art would further understand that the metes and bounds of the term “about” with respect to the value of a percentage, amount or quantity of any component in an embodiment can be determined by varying the value, determining the effectiveness of the compositions for each value, and determining the range of values that produce compositions with the desired degree of effectiveness in accordance with the present disclosure. The term “about” is further used to reflect the possibility that a composition may contain trace components of other materials that do not alter the effectiveness of the composition.

In the present disclosure, the term “substantially” refers to a degree of deviation that is sufficiently small so as to not measurably detract from the identified property or circumstance. The exact degree of deviation allowable may in some cases depend on the specific context.

The coating composition may be applied to any substrate that is in need of a durable and slip or skid resistant coating. The coating composition may be applied to any horizontal or substantially horizontal surface that experiences pedestrian or vehicular traffic. For example, and without limitation, the coating composition may be applied to building floors, balcony decks, parking decks, parking ramps, plaza decks, stadium decks, stairs and the like.

One or more layers of the coating composition may be applied to the surface of a substrate to provide a slip- or skid-resistant coating on the surface of the substrate. The coating composition may be applied to the surface of a substrate with a brush, mop, roller, squeegee, sprayer or other equivalent means. The liquid coating composition may be applied to a wide variety of substrates, such as concrete, masonry, cement board, gypsum board, plywood, particle board, oriented strand board and the like.

Also disclosed is a method for coating a surface of a substrate with a coating, said method comprising coating at least one layer of a coating composition comprising a polymer matrix and a mineral aggregate substantially free of crystalline silica on at least a portion of a surface of said substrate. According to certain embodiments, the polymer matrix is applied to a substrate using a brush, roller, squeegee or like instrument to effectively apply a layer of the polymer matrix having a thickness of generally between about 1/16″ to about ¼″ thick. Immediately following application of the polymer matrix to the surface of the substrate, the disclosed mineral aggregate can be manually backrolled or broadcast further across the exposed surface of the polymer matrix layer so as to effectively spread and settle within the polymer matrix layer prior to curing. For example, and without limitation, the coating composition can be used on pedestrian and vehicular applications.

Curing of the disclosed coating composition can proceed very rapidly, and in general can take place at a temperature within the range of from about −10° C. to about +50° C., particularly from about 0° C. to about +40° C., more particularly from about +5 to about +35° C.

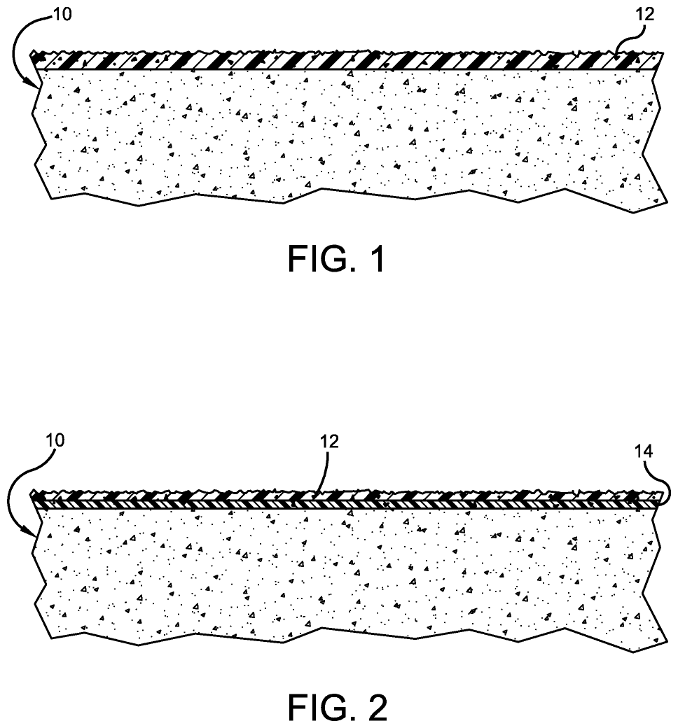

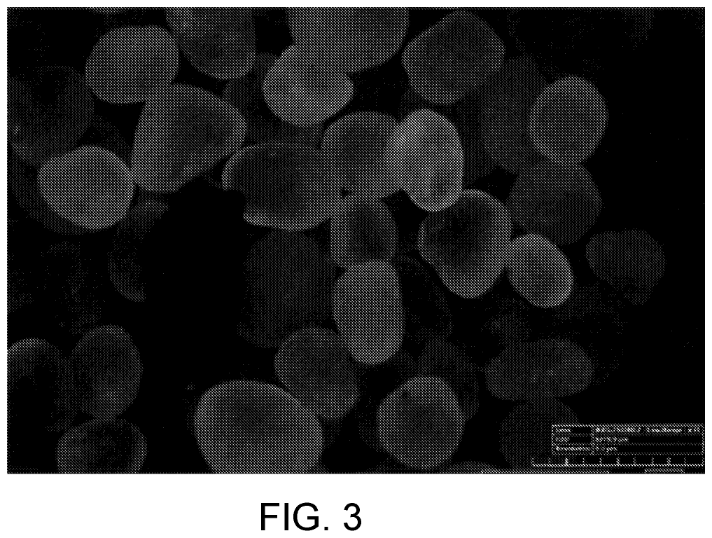

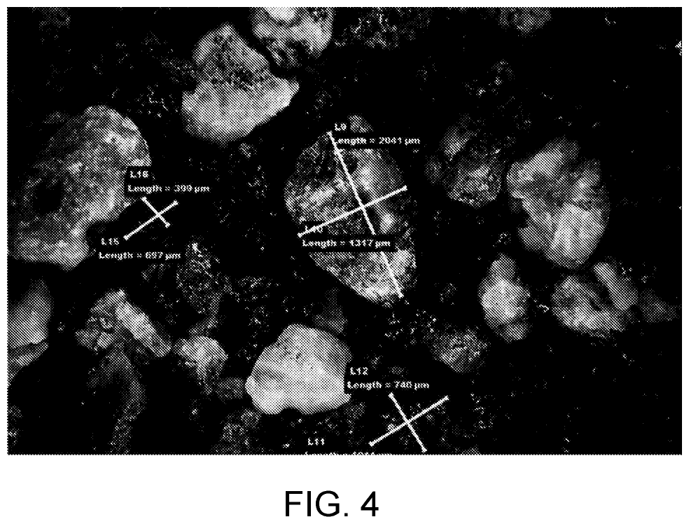

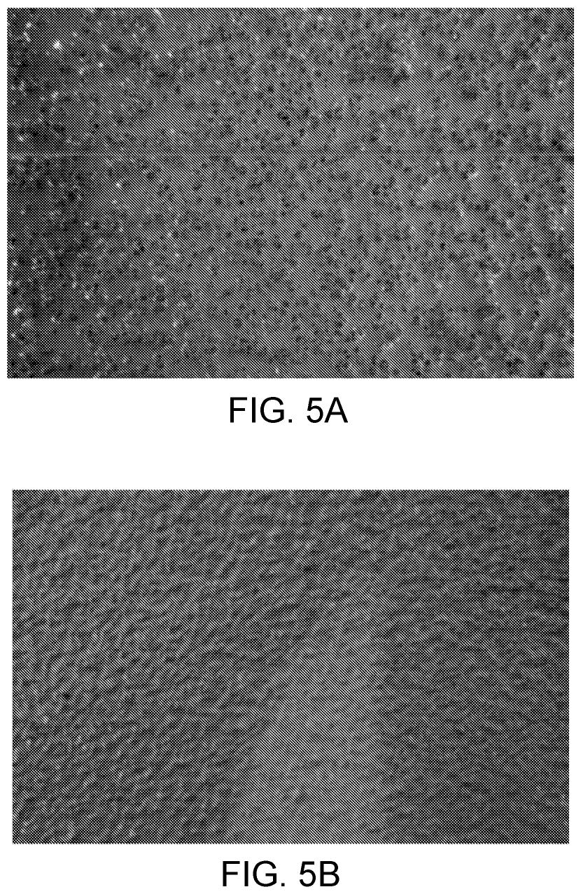

The slip-resistant coating composition is readily understood when read in conjunction with illustrative FIGS. 1-2. It should be noted that the slip-resistant coating composition is not limited to any of the illustrative embodiments shown in the drawing figures, but rather should be construed in breadth and scope in accordance with the disclosure provided herein.

FIG. 1 is a cross-sectional view of a substrate (10) coated with an illustrative slip-resistant coating composition (12) comprising a polymer matrix and a mineral aggregate substantially free of crystalline silica. According to certain embodiments, the substrate (10) is first cleaned with conventionally-known commercial cleansers so as to remove any foreign substances such as oils, loose granular particles and the like. The cleaned substrate (10) may optionally be mechanically abraded to impart a roughened porous surface. The substrate (10) may then be cleaned again to remove dust and debris that was generated from the abrasion process. Once the substrate (10) has been properly cleaned and roughened, it is ready for application of the slip-resistant coating composition (12).

FIG. 2 is a cross-sectional view of a substrate (10) coated with a base coat (14), such as a primer, which is then top coated with an illustrative slip-resistant coating composition (12) comprising a polymer matrix and a mineral aggregate substantially free of crystalline silica.

### EXAMPLES

The following examples are set forth merely to further illustrate the coating composition and methods of making the coating composition. The illustrative examples should not be construed as limiting the coating composition, the coated substrate incorporating the coating composition, or the methods of making or using the coating composition in any manner.

Table 1 provides the chemical composition of the mineral aggregate used in the following experiments.

TABLE 1

| Ingredient | % wt. | CAS Number |
|---|---|---|
| SiO₂ | 50.2 | 112926-00-8 |
| (Amorphous Silica)* | | |
| MgO | 31.4 | 1309-48-4 |
| (Magnesium Oxide) | | |
| Fe₂O₃ | 15.9 | 1309-37-1 |
| (Iron Oxide) | | |
| Al₂O₃ | 1.6 | 1344-28-1 |
| (Aluminum Oxide) | | |
| CaO | 0.7 | 1305-78-8 |
| Calcium Oxide | | |
| Ni (Nickel) | <0.1 | 7440-02-0 |
| and | | |
| NiO (Nickel Oxide) | | |
| Cr2O3 | 0.1 | 1308-38-9 |
| (Chromium Oxide) | | |
| Trace Elements and Compounds | 1.5 | N/A |

*Contains no free crystalline silica

### Visual Analysis

### Example 1

A liquid applied one-component moisture-curing polyurethane coating (MASTERSEAL 225) was used to coat a 10 ft×10 ft substrate area. Prior to curing the polyurethane coating, the mineral aggregate was spread by broadcasting across the surface of the coated substrate area. The mix ratio of the polyurethane coating to the mineral aggregate was 2/1 by volume.

### Example 2

A liquid applied two-component moisture-curing polyurethane coating (MASTERSEAL 275) was used to coat a 10 ft×10 ft substrate area. Part A and Part B was mixed for about 2-3 minutes. Prior to curing the polyurethane coating, the mineral aggregate was spread by broadcasting across the surface of the coated substrate area. The mix ratio of the polyurethane coating to the mineral aggregate was 2/1 by volume.

### Example 3

Part A and Part B of a liquid applied two-component moisture-curing polyurethane coating (MASTERSEAL 295) was mixed for about 2-3 minutes. Prior to curing the polyurethane coating, the mineral aggregate was spread by broadcasting across the surface of the coated substrate area The mix ratio of the polyurethane coating to the mineral aggregate was 3/1.5 by volume.

### Example 4

The mineral aggregate was mixed with a liquid applied one-component moisture-curing polyurethane coating (MASTERSEAL 225). The mix ratio of the polyurethane coating to the mineral aggregate was 4/1 by volume. The mineral aggregate was mixed with the polyurethane matrix for about 2-3 minutes. The mixture was then rolled onto a 10 ft×10 ft substrate area with a ⅜″ roller and a 3/16″ roller.

Upon visual inspection of the coatings of Examples 1-4 above, it was determined that each cured coating composition exhibited consistent and adequate texture for wet and dry slip resistance for both pedestrian and vehicular applications.

### Slip Resistance Testing

The slip resistance properties for certain coating compositions were carried out under dry and wet conditions. A Gibson Pendulum Slip Tester (“Slip Tester”) was used to determine the slip resistance of certain coating compositions. The Slip Tester measures the frictional resistance between a rubber slider mounted on the end of a pendulum arm and a test surface. A pendulum consisting of a tubular arm rotates about a spindle attached to a vertical pillar. At the end of the tubular arm, a head of constant mass is fitted with a rubber slider. The pendulum is released from a horizontal position so that it strikes the test surface with a constant velocity. The distance traveled by the head after striking the test surface is determined by the friction of the test surface. The energy of the upswing is inversely related to the slip resistance and is quantified using a needle.

### Slip Resistance Test 1

Samples 1-3 were prepared using polymer matrices comprising polyurethane polymers that are commercially available from BASF Corporation (Florham Park, N.J., USA) under the designations MASTERSEAL 225, 275 and 295. The mineral aggregate was broadcast onto the surface of a test surface that was coated with the polymer matrix. In all of the samples, the mix ratio of the polymer matrix to the mineral aggregate was 2/1 by volume. The comparative examples included MASTERSEAL 225, 275 and 295 polyurethane polymers with crystalline silica aggregate (Unimin 2095) broadcast onto the surface of a test surface that was coated with the polymer matrix. The results of the slip resistance testing are shown in Table 2.

TABLE 2

| | Polymer | Amorphous silica | | Crystalline silica | |
|---|---|---|---|---|---|
| Example | matrix | Aggregate | | Aggregate | |
| — | — | Dry | Wet | Dry | Wet |
| 8 | 295 | 78.3 | 75.3 | — | — |
| C9 | 295 | — | — | 75 | 62 |
| 10 | 275 | 85.3 | 77 | — | — |
| C11 | 275 | — | — | 79 | 69.5 |
| 12 | 225 | 75.3 | 71.6 | — | — |
| C13 | 225 | — | — | 71.2 | 62.4 |

Table 2 shows an overall improvement in both dry and wet slip resistance of coating compositions comprising the disclosed mineral aggregate, as compared to the same coating compositions except having crystalline silica aggregate instead of the disclosed mineral aggregate. In addition to the advantage of the present coating composition of minimizing or eliminating workers' exposure to respirable crystalline silica, it was surprisingly found that the substrates coated with the disclosed coating composition exhibited an enhanced degree of dry and wet skid resistance. These coatings when applied to a substrate create a surface profile with enhanced and improved non-skid properties over the current art.

While the coating composition, coated substrate, and methods of making the coating composition and coating a substrate with the coating composition have been described in connection with various illustrative embodiments, it is to be understood that other similar embodiments may be used or modifications and additions may be made to the described embodiments for performing the same function disclosed herein without deviating therefrom. The illustrative embodiments described above are not necessarily in the alternative, as various embodiments may be combined to provide the desired characteristics. Therefore, the coating, the coated substrate and methods should not be limited to any single embodiment, but rather construed in breadth and scope in accordance with the recitation of the appended claims.

1. A coating comprising a polymer matrix and a mineral aggregate substantially free of crystalline silica.

2. The coating of claim 1, wherein the coating comprises less than 10 weight percent crystalline silica.

3-5. (canceled)

6. The coating of claim 1, wherein the mineral aggregate comprises greater than about 25 weight percent amorphous silica.

7. (canceled)

8. The coating of claim 6, wherein the mineral aggregate comprises greater than about 45 weight percent amorphous silica.

9. The coating of claim 8, wherein the mineral aggregate comprises greater than about 50 weight percent amorphous silica.

10. The coating of claim 1, wherein the mineral aggregate comprises from about 30 to about 70 weight percent amorphous silica and from about 20 to about 40 weight percent magnesia.

11. The coating of claim 10, wherein the mineral aggregate comprises from about 40 to about 60 weight percent amorphous silica and from about 25 to about 35 weight percent magnesia.

12. The coating of claim 11, wherein the mineral aggregate comprises from about 45 to about 55 weight percent amorphous silica, from about 25 to about 35 weight percent magnesia and from about 10 to about 20 weight percent iron oxide.

13. The coating of claim 1, wherein said polymer matrix is selected from at least one of epoxy, polyaspartic, polymethacrylate, polyurethane, polyurea, or epoxy polysulfide.

14. The coating of claim 13, wherein said polymer matrix comprises polyurethane.

15. The coating of claim 1, wherein a ratio of the longest dimension to the shortest dimension of said mineral aggregate is greater than 1.4:1.

16. The coating of claim 1, wherein a ratio of said polymer matrix to said mineral aggregate in the coating composition is in the range of about 2:1 to 5:1.

17. The coating of claim 16, wherein the ratio of polymer matrix to said mineral aggregate in the coating composition is about 2:1.

18. The coating of claim 6, wherein said amorphous silica particles have a non-round or non-spherical, angular shape.

19. The coating of claim 16, wherein the densities of the polymer matrix and the mineral aggregate are with ±20 percent of each other.

20. A coated substrate comprising:
a substrate having opposite facing first and second major surfaces; and
at least one layer of said coating of claim 1 on one of said first or second major surfaces of said substrate.

21. The coated substrate of claim 20, wherein said substrate comprises a floor substrate.

22. The coated substrate of claim 20, wherein said substrate comprises a deck substrate.

23. A method for coating a substrate comprising:
applying at least one layer of the coating of claim 1 to a surface of a substrate.

24. A method for coating a substrate comprising:
applying at least one layer of a polymer matrix to a surface of a substrate; and
applying a plurality of mineral aggregates substantially free of crystalline silica onto said polymer matrix.
